(19) United States
(12) Patent Application Publication
(10) Pub. No.: US 2010/0043236 A1
(43) Pub. Date: Feb. 25, 2010

(54) FOOD PROCESSOR

(76) Inventor: Christopher Robert McNair-Chaplin, Cornwall (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 12/523,761

(22) PCT Filed: Dec. 18, 2007
(86) PCT No.: PCT/GB07/04857

§ 371 Date: Jul. 20, 2009

(30) Foreign Application Priority Data
Mar. 30, 2007 (GB) 0706244.1

(51) Int. Cl. B26B 27/00

(52) U.S. Cl. 30/173

(57) ABSTRACT

A cutter head (100) for use with a hand-held rotary food processor, including a hub portion (101) in which a plurality of axially extending cutting blades (103) are mounted in recesses (102) in the hub each cutting blade having a longitudinal slot formed therein and being so positioned in the respective recess in the hub that one edge (302) of the slot is superimposed above the centre line of the recess so as to form the cutting edge of the cutting blade.

The present invention relates to food processors, that is to say, devices for facilitating the preparation of food for consumption and more particularly to hand-held electrically operated devices for partially or completely removing the outer surfaces of fruit and vegetables. For the purposes of this specification, such devices are referred to as peeler/zesters.

A known form of peeler/zester has a frusto-conical rotating cutter head which is provided with a plurality of axially extending cutting blades fitted into recesses spaced regularly around it. Each of the cutting blades has a longitudinal slot formed in it, the edge of which that faces the direction of rotation of the cutter head forming the cutting edge of the cutting blade. The cutting blades are installed in their respective recesses in the cutter head in such a way that the centre lines of the slots in the cutting blades are superimposed upon the centre lines of the recesses into which the cutting blades are fitted. This arrangement has been found to suffer from the disadvantage that the effectiveness of the cutting blades is sensitive to the accuracy of the manufacturing of the cutting blades.

It is an object of the present invention to provide an improved cutter head for a food processor of the type described above which is less sensitive to the accuracy of the manufacture of cutting blades which form part of the cutter head.

According to the present invention there is provided a cutter head assembly for use with a rotary food processor, including a longitudinally extending hub portion with a plurality of axially extending recesses spaced regularly around the periphery thereof each of the recesses having a cutting blade installed therein, each cutting blade having a longitudinal slot formed therein and being installed in the respective recess in the hub of the cutter head such that one edge of the slot of the cutting blade is superimposed above the centre line of the said recess in the hub of the cutter head.

The edge of the slot in each cutting blade which is superimposed above the centre line of the recess in which it is installed forms the cutting edge of the cutting blade.

Successive cutting blades may be installed with alternate edges of the slots superimposed above the centre lines of the respective recesses in which they are installed so that the cutting edges of the cutting blades face in opposite directions and the cutter head will operate regardless of whether it is rotating in a clockwise or anti-clockwise direction with respect tot he surface of an item of fruit or vegetable being processed by the apparatus.

Preferably, the hub portion of the cutter head in which the cutting blades are installed is frusto-conical with an angle of taper in the region of five degrees.

The invention will now be described, by way of example only, with reference to the accompanying drawings, in which:

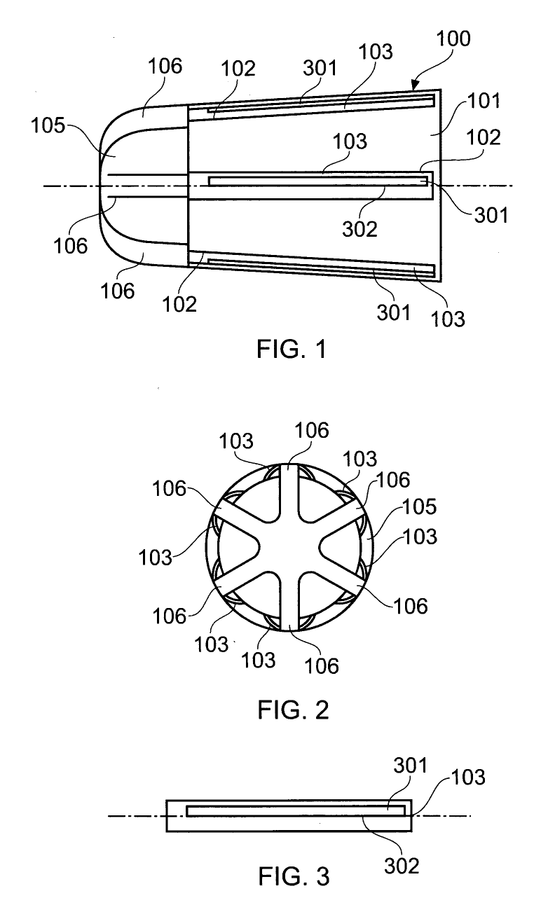

FIG. 1 is a side view of a cutter head embodying the invention,

FIG. 2 is an end view of the cutter head of FIG. 1 and

FIG. 3 is a plan view of a cutting blade as incorporated in the cutter head of FIG. 1.

Referring to the drawings, a cutter head assembly 100 for use with a hand-held, electrically powered peeler/zester apparatus consists of a hub 101 of frusto-conical form which is adapted to be attached to a drive shaft of an electric motor unit, neither of which is shown in the drawings. Spaced regularly around the periphery of the hub 101 are six axially extending recesses 102 in each of which there is located a cutting blade 103. Six is a convenient number of cutting blades 103, but more or fewer can be used if so desired. Each of the cutting blades 103 is part-cylindrical in section and has a longitudinal slot 301 formed in it. The slot 301 is so formed that one edge 302 of the slot 301 coincides with the centre line 303 of the cutting blade 103. The cutting blade 103 is installed in its recess 102 with the edge 302 of the slot 301 superimposed above the centerline of the recess 102. The edge 302 of the slot 301 in the cutting blade 103 forms the cutting edge of the cutting blade 103. Alternatively, the slot 301 may be formed symmetrically with respect to its cutting blade 103 and the cutting blade 103 may be installed in its respective recess 102 in such a way that one edge of the slot 301 in the cutting blade 103 is superimposed above the centre line of the recess 102 so as to form the cutting edge of the cutting blade 103, as before. Successive cutting blades 103 are installed in their respective recess 102 in the hub 101 with their cutting edges facing in opposite directions so that the cutter head 100 will function whether it is rotating in a clockwise or counter-clockwise sense with respect to an item of fruit or vegetable being operated upon by the peeler/zester.

Attached to, or integral with, the frusto-conical hub 101 is a domed end cap 105, which is provided with six regularly spaced radially extending vanes 106. The vanes 106 form extensions of the cutting blades 103. The vanes 106 have sharp edges and a profile which also is domed. The vanes 106 are used for operations such as removing eyes from potatoes. If other than six cutting blades 103 are used, then so is the same number of vanes 106.

In the embodiment of the invention described above, the hub 101 is frusto-conical in form. This is not a necessary feature of the invention; the hub 101 could be cylindrical or ribbed in form if so desired. Also, the width of the slot 301 in the cutting blade 103 determines the coarseness of the cutting action of the cutting blade 103 and the edge 302 of the slot 301 which forms the cutting edge can be provided with indentations so as to produce peelings which vary in thickness, thus improving their cosmetic appeal.

1-7. (canceled)

8. A cutter head assembly for use with a rotary food processor, said cutter head assembly comprising:
an axially extending hub with a plurality of longitudinally extending recesses defined and spaced regularly around a periphery thereof, said hub adapted to be attachable to a drive shaft of said rotary food processor; and
at least one cutting blade receivable in each of said recesses, each of said cutting blade having a longitudinal slot defined therein and being receivable in said respective recess in said hub such that one edge of said slot in said cutting blade is superimposed above a centre line of said recess of said hub thereby to form a cutting edge of said cutting blade.

9. The cutter head assembly according to claim 8, wherein successive cutting blades are installed in said hub with their cutting edges facing in opposite directions.

10. The cutter head assembly according to claim 9, wherein said cutting edges of said cutting blades are provided with indentations.

11. The cutter head assembly according to claim 10, wherein said hub has a substantially cylindrical configuration.

12. The cutter head assembly according to claim 8 further comprising an end cap being provided with radially extending vanes, said end cap being attachable to said hub.

13. The cutter head assembly according to claim 12, wherein each of said vanes is aligned with each cutting blade.

14. The cutter head assembly according to claim 13, wherein said end cap has a substantially domed profile.

15. The cutter head assembly according to claim 14, wherein said vanes of said end cap each having a cutting edge.

16. The cutter head assembly according to claim 8, wherein said cutting blade each is part-cylindrical in section.

17. A cutter head assembly comprising:
an axially extending hub with a plurality of longitudinally extending recesses defined and spaced regularly around a periphery thereof, said hub adapted to be attachable to a drive shaft of said rotary food processor;
at least one cutting blade installed in each of said recesses, each of said cutting blade having a longitudinal slot defined therein and being installed in said respective recess in said hub such that one edge of said slot in said cutting blade is superimposed above a centre line of said recess of said hub thereby to form a cutting edge of said cutting blade; and
an end cap having radially extending vanes aligned with each said cutting blade, said end cap being attachable to a free end of said hub.

18. The cutter head assembly according to claim 17, wherein successive cutting blades are installed in said hub with their cutting edges facing in opposite directions.

19. The cutter head assembly according to claim 18, wherein said cutting edges of said cutting blades are provided with indentations.

20. The cutter head assembly according to claim 18, wherein said hub has a substantially cylindrical configuration.

21. The cutter head assembly according to claim 17, wherein said end cap has a substantially domed profile.

22. The cutter head assembly according to claim 21, wherein said vanes of said end cap each having a cutting edge.

23. The cutter head assembly according to claim 17, wherein said cutting blade each is part-cylindrical in section.

24. A cutter head assembly comprising:
an axially extending hub having a substantially cylindrical configuration, said hub having a plurality of longitudinally extending recesses defined and spaced regularly around a periphery thereof, said hub adapted to be attachable to a drive shaft of said rotary food processor;
at least one cutting blade installed in each of said recesses, each of said cutting blade having a longitudinal slot defined therein and being installed in said respective recess in said hub such that one edge of said slot in said cutting blade is superimposed above a centre line of said recess of said hub thereby to form a cutting edge of said cutting blade; and
an end cap having a substantially domed profile and radially extending vanes aligned with each said cutting blade, said end cap being attachable to a free end of said hub;
wherein successive cutting blades are installed in said hub with their cutting edges facing in opposite directions.

25. The cutter head assembly according to claim 24, wherein said cutting edges of said cutting blades are provided with indentations.

26. The cutter head assembly according to claim 24, wherein said vanes of said end cap each having a cutting edge.

27. The cutter head assembly according to claim 24, wherein said cutting blade each is part-cylindrical in section.
